(19) United States
(12) Patent Application Publication
(10) Pub. No.: US 2018/0091623 A1
(43) Pub. Date: Mar. 29, 2018

(54) SYSTEM

(71) Applicant: SEIKO EPSON CORPORATION, Tokyo (JP)

(72) Inventors: Shoichi OYAMA, Azumino-shi (JP); Eiji MIYASAKA, Okaya-shi (JP)

(73) Assignee: SEIKO EPSON CORPORATION, Tokyo (JP)

(21) Appl. No.: 15/700,548

(22) Filed: Sep. 11, 2017

(30) Foreign Application Priority Data
Sep. 27, 2016 (JP) 2016-187876

(51) Int. Cl. H04L 29/08; G01S 19/05

(52) U.S. Cl. CPC H04L 67/325; H04W 76/02; G01S 19/05

(57) ABSTRACT

An exercise support system functioning as a system that performs communication connection between a wrist device and a portable device at time when the user sets in advance that the wrist device is not used. After the communication connection is performed, the wrist device transmits measurement information measured by the wrist device to the portable device. The portable device transmits the measurement information received from the wrist device to a server on a network. The server saves the measurement information received from the portable device.

### BACKGROUND

### 1. Technical Field

The present invention relates to a system including a wrist device and a portable device.

### 2. Related Art

For example, JP-T-2012-524638 (Patent Literature 1) discloses a portable GPS electronic device (a wrist device) that measures an exercise performance and is capable of performing wireless communication and an exercise performance monitoring system including the portable GPS electronic device. For example, WO 2004/015606 (Patent Literature 2) discloses a system that transmits exercise information, which is measured by a wrist device and saved, to a database server on the Internet by wireless communication via a cellular phone functioning as a portable device.

However, in the systems disclosed in Patent Literature 1 and Patent Literature 2, if a data amount of exercise information measured and retained by the wrist device is large, a transmission time to the server is long and the wrist device cannot be used during the transmission, that is, the wrist device cannot be used for a long time.

### SUMMARY

An advantage of some aspects of the invention is to solve at least a part of the problems described above, and the invention can be implemented as the following forms or application examples.

### APPLICATION EXAMPLE 1

A system according to this application example performs communication connection between a wrist device and a portable device at time when the user sets in advance that the wrist device is not used. After the communication connection is performed, the wrist device transmits measurement information measured by the wrist device to the portable device. The portable device transmits the measurement information received from the wrist device to a server on a network. The server saves the measurement information received from the portable device.

According to this application example, the communication connection is performed between the wrist device and the portable device at the time when the user sets in advance that the wrist device is not used. After the communication connection is performed, that is, while the user does not use the wrist device, in other words, while functions such as measurement does not work in the wrist device, it is possible to transmit the measurement information from the wrist device to the server on the network via the portable device and save the measurement information in the server. Therefore, it is possible to eliminate a trouble that the user cannot use the wrist device during the transmission of the measurement information.

### APPLICATION EXAMPLE 2

A system according to this application example is a system in which a wrist device recognizes that the wrist device is at a standstill, a portable device recognizes that the portable device is at a standstill, the wrist device and the portable device transmit radio waves to each other on the basis of the recognitions and perform communication connection between the wrist device and the portable device on the basis of the radio waves transmitted to each other. After the communication connection is performed, the wrist device transmits measurement information measured by the wrist device to the portable device. The portable device transmits the measurement information received from the wrist device to a server on a network. The server saves the measurement information received from the portable device.

According to this application example, the wrist device and the portable device respectively recognize that the wrist device and the portable device are at a standstill, transmit the radio waves, and perform the communication connection. After the communication connection is established, while the wrist device and the portable device are at a standstill, that is, the wrist device and the portable device are not used, it is possible to transmit the measurement information from the wrist device to the server on the network via the portable device and save the measurement information in the server. Therefore, it is possible to eliminate a trouble that the user cannot use the wrist device during the transmission of the measurement information.

Note that “the wrist device and the portable device are at a standstill” indicates a state in which movement (motion) of the wrist device and the portable device stops, that is, a state in which the wrist device and the portable device are placed away from the user.

### APPLICATION EXAMPLE 3

In the system according to the application example, it is preferable that the communication connection is performed by Bluetooth (registered trademark) communication.

According to this application example, it is possible to easily perform the communication connection between the wrist device and the portable device through the Bluetooth communication that has less directivity, has convenience of simple digital wireless communication, and is suitable for mobile communication.

### APPLICATION EXAMPLE 4

In the system according to the application example, it is preferable that the Bluetooth communication is communication by Bluetooth Low Energy.

According to this application example, since the communication is performed by the Bluetooth Low Energy, it is possible to greatly save electric power compared with versions in the past. It is possible to increase a usable time of the wrist device.

### APPLICATION EXAMPLE 5

In the system according to the application example, it is preferable that the wrist device includes a global navigation satellite system.

According to this application example, the user can obtain, with the wrist device, accurate position information of the user based on the global navigation satellite system (GNSS).

### APPLICATION EXAMPLE 6

In the system according to the application example, it is preferable that the global navigation satellite system is a GPS (Global Positioning System), and the server transmits assist data of the GPS to the wrist device after the saving of the measurement information is completed.

According to this application example, since after the saving of the measurement information that reduces a load on the wrist device is completed, the assist data of the GPS (Global Positioning System) is transmitted to the wrist device, the wrist device can surely obtain the assist data of the GPS.

### APPLICATION EXAMPLE 7

In the system according to the application example, it is preferable that the server transmits the assist data of the GPS to the wrist device on the basis of measurement start time set in advance by the user.

According to this application example, since the assist data of the GPS is transmitted to the wrist device on the basis of the measurement start time set in advance by the user, the wrist device can surely obtain the assist data of the GPS.

### APPLICATION EXAMPLE 8

In the system according to the application example, it is preferable that the server transmits the assist data of the GPS to the wrist device on the basis of transmission time set in advance by the user.

According to this application example, since the assist data of the GPS is transmitted to the wrist device on the basis of transmission time set in advance by the user, the wrist device can surely obtain the assist data of the GPS.

### BRIEF DESCRIPTION OF THE DRAWINGS

The invention will be described with reference to the accompanying drawings, wherein like numbers reference like elements.

FIG. 1 is a schematic configuration diagram showing an overview of an exercise support system, which is an example of a system according to the invention.

FIG. 2 is an exterior view showing a schematic configuration of a wrist device used in the exercise support system.

FIG. 3 is an exterior view showing a wearing example of the wrist device.

FIG. 4 is a sectional view showing the configuration of the wrist device.

FIG. 5 is a block diagram showing a configuration example of the exercise support system.

FIG. 6 is a flowchart for explaining an example 1 of an operation procedure of the exercise support system.

FIG. 7 is a diagram for explaining timing of communication connection of the example 1.

FIG. 8 is a flowchart for explaining an example 2 of the operation procedure of the exercise support system.

FIG. 9 is a flowchart showing an illustration 1 of a transmission procedure of assist data of a GPS related to an A-GPS.

FIG. 10 is a flowchart showing an illustration 2 of the transmission procedure of the assist data of the GPS related to the A-GPS.

FIG. 11 is a diagram for explaining transmission timing of the illustration 2.

FIG. 12 is a flowchart for explaining an illustration 3 of the transmission procedure of the assist data of the GPS related to the A-GPS.

FIG. 13 is a diagram for explaining transmission timing of the illustration 3.

FIG. 14 is a block diagram showing a modification related to the configuration of the wrist device.

### DESCRIPTION OF EXEMPLARY EMBODIMENTS

An embodiment of a system according to the invention is explained below. Note that the embodiment explained below does not unduly limit the content of the invention described in the appended claims. Not all of components explained in the embodiment are always essential constituent elements of the invention.

1. Method of this Embodiment

First, a method of an exercise support system, which is an example of a system according to the embodiment of the invention, is explained. In the following explanation, as a detection device used in the exercise support system, for example, a wrist device (a wearable device) including a pulse wave sensor and a body motion sensor mounted on a wrist of a user is illustrated and explained.

The wrist device included in the exercise support system includes the pulse wave sensor that acquires a pulse wave serving as a biological information of the user and a body motion sensor that acquires motion information of the user. Further, the wrist device includes a GPS (Global Positioning System), which is an example of a positioning system that uses a position information satellite called a global navigation satellite system (GNSS) or the like that acquires position information of the user. Note that the wrist device may be a wearable device worn on another part of the user such as a neck or an ankle.

The pulse wave sensor is capable of acquiring pulse wave information such as a pulse rate. As the pulse wave sensor, for example, a photoelectric sensor (an optical sensor) is used. In this case, it is conceivable to adopt, for example, a method of detecting, with the photoelectric sensor, reflected light or transmitted light of light irradiated on a living organism. Since an absorption amount and a reflection amount of the irradiated light in the living organism are different depending on a blood flow rate in a blood vessel, sensor information detected by the photoelectric sensor is a signal corresponding to the blood flow rate and the like. It is possible to acquire information concerning pulsation by analyzing the signal. However, the pulse wave sensor is not limited to the photoelectric sensor. Other sensors such as an electrocardiograph and an ultrasonic sensor may be used.

Note that the photoelectric sensor (the optical sensor) needs to receive necessary light and block unnecessary light. In an example of the pulse wave sensor, the pulse wave sensor needs to receive, as intense light, reflected light including a pulse wave component reflected on a subject (in particular, apart including a measurement target blood vessel), which is a target of measurement, and block other lights because the other lights are noise components.

The body motion sensor is a sensor that detects a body motion of the user. As the body motion sensor, it is conceivable to use an acceleration sensor, an angular velocity sensor, an azimuth sensor (a terrestrial magnetism sensor), a pressure sensor (an altitude sensor), or the like. However, other sensors may be used.

The GPS is also called global positioning system and is a satellite positioning system for positioning a present location on the Earth on the basis of a plurality of satellite signals. The GPS includes a function of performing positioning calculation using GPS time information and orbit information and acquiring position information of the user and time correcting function in clock function.

### 2. Exercise Support System

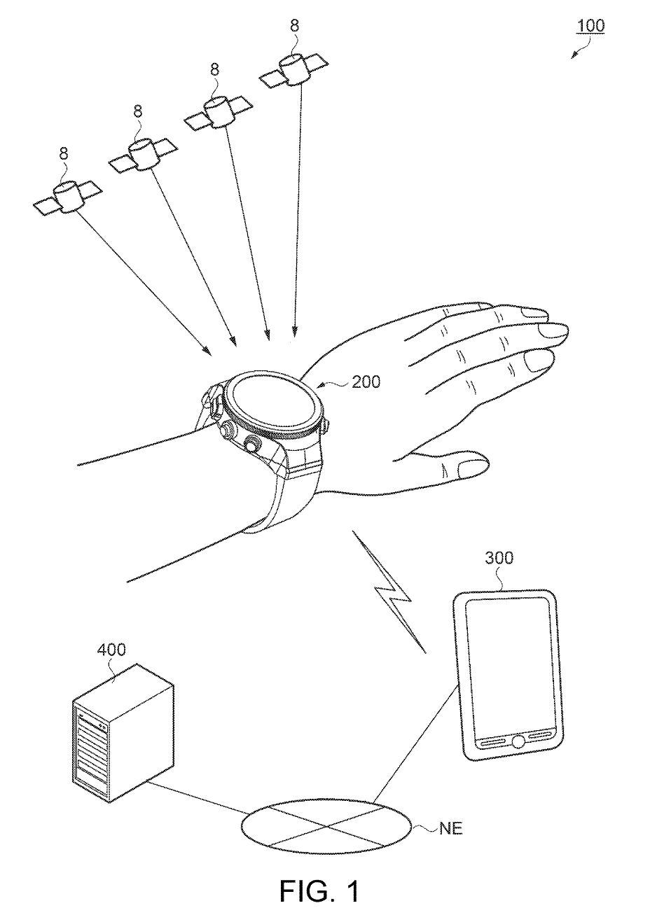

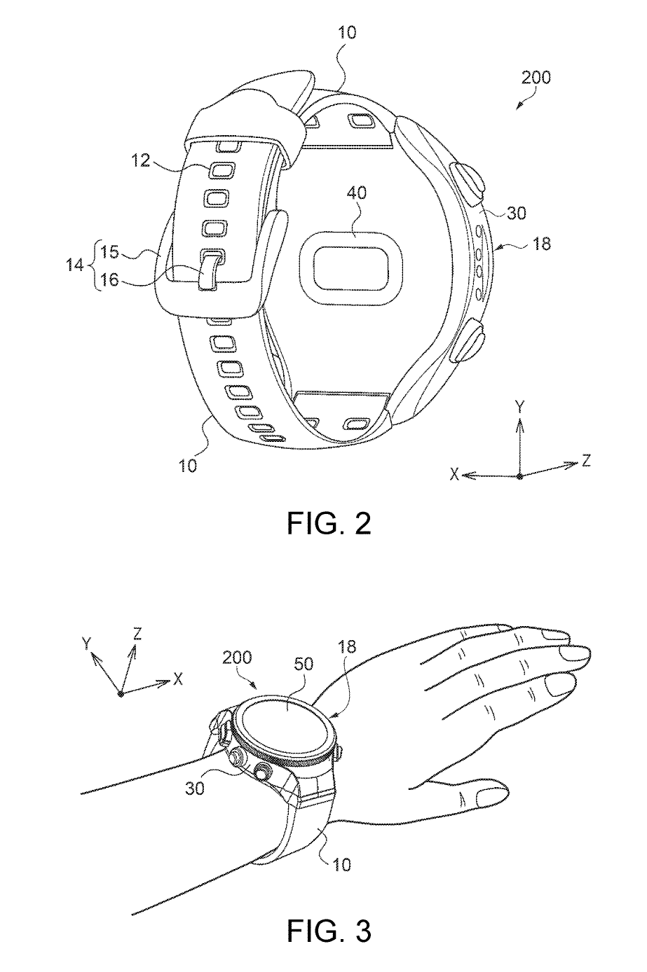

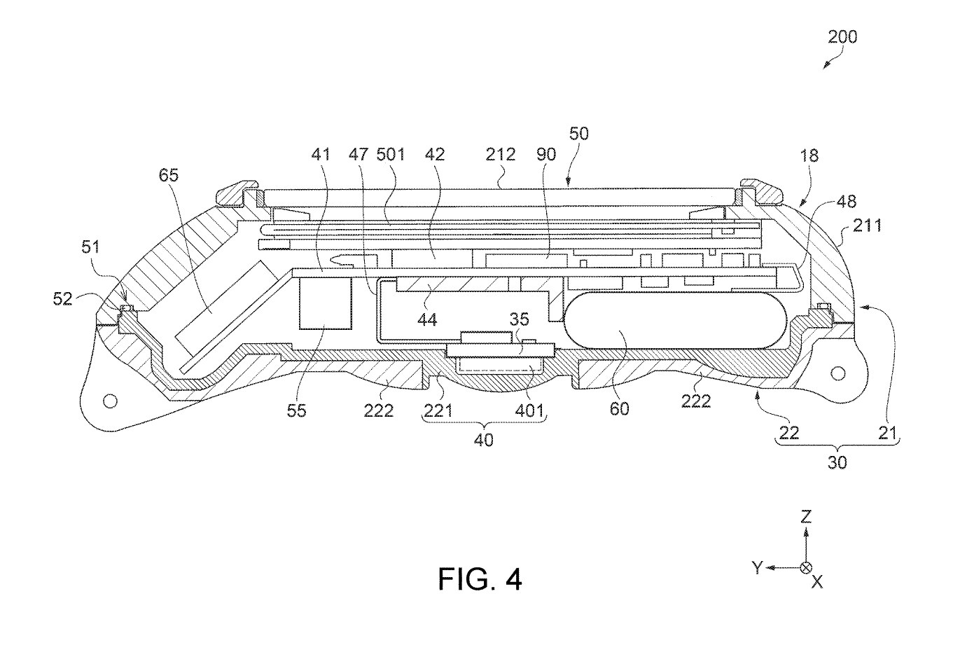

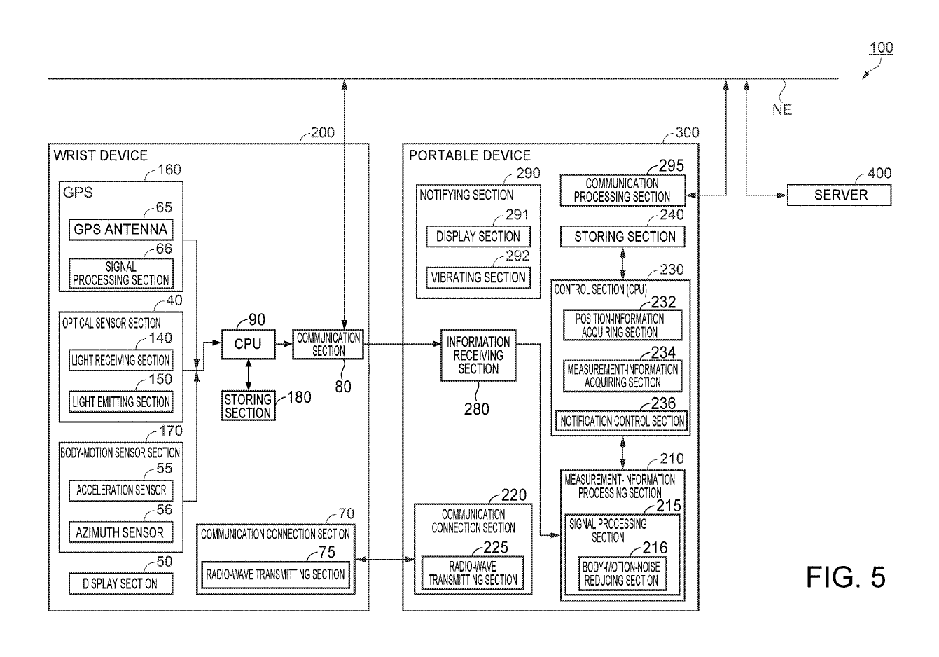

The configuration of the exercise support system, which is an example of the system according to the embodiment of the invention, is explained with reference to FIGS. 1, 2, 3, 4, and 5. FIG. 1 is a schematic configuration diagram showing an overview of the exercise support system, which is an example of the system according to the embodiment of the invention. FIG. 2 is an exterior view showing a schematic configuration of the wrist device used in the exercise support system. FIG. 3 is an exterior view showing a wearing example of the wrist device. FIG. 4 is a sectional view showing the configuration of the wrist device. FIG. 5 is a block diagram showing a configuration example of the exercise support system.

An exercise support system 100 according to this embodiment includes, as shown in FIG. 1, a wrist device 200 functioning as a detection device including a pulse wave sensor functioning as a biological sensor (a photoelectric sensor) and a GPS, a portable device 300 functioning as an exercise supporting device, and a server 400 functioning as an information processing device connected to the portable device 300 via a network NE.

The GPS functioning as a global navigation satellite system included in the wrist device 200 includes a function of receiving a radio wave (a satellite signal) from a GPS satellite 8 to correct internal time and performing positioning calculation to acquire position information.

The GPS satellite 8 is an example of a position information satellite that orbits on a predetermined orbit in the sky of the Earth. The GPS satellite 8 transmits a high-frequency radio wave, for example, a radio wave (an L1 wave) of 1.57542 GHz superimposed with a navigation message to the ground. In the following explanation, the radio wave of 1.57542 GHz superimposed with the navigation message is referred to as satellite signal. The satellite signal is a right-handed circularly polarized wave.

Currently, a plurality of GPS satellites 8 (in FIG. 1, only four GPS satellites 8 are shown) are present. In order to identify from which GPS satellites 8 satellite signals are transmitted, the GPS satellites 8 superimpose peculiar patterns of 1023 chips (1 ms cycle) called C/A codes (Coarse/Acquisition Codes) on satellite signals. Chips of the C/A codes are either one of +1 and −1. The C/a codes are seen like random patterns. Therefore, by correlating the satellite signals and the patterns of the C/A codes, it is possible to detect the C/A codes superimposed on the satellite signals.

The GPS satellites 8 are mounted with atomic clocks. The satellite signals include extremely accurate GPS time information clocked by the atomic clocks. A slight time error of the atomic clocks mounted on the GPS satellites 8 is measured by a control segment on the ground. The satellite signals also include time correction parameters for correcting the time error. The wrist device 200 can receive the satellite signal (a radio wave) transmitted from one GPS satellite 8 and acquire time information using the GPS time information and the time correction parameters included in the satellite signal.

The satellite signals also include orbit information indicating positions on orbits of the GPS satellites 8. The wrist device 200 can perform positioning calculation using the GPS time information and the orbit information. The positioning calculation is performed on the premise that a certain degree of an error is included in the internal time of the wrist device 200. That is, the time error is an unknown quantity in addition to x, y, and z parameters for specifying a three-dimensional position of the wrist device 200. Therefore, the wrist device 200 can receive satellite signals (radio waves) respectively transmitted from, for example, three or more GPS satellites 8, perform the positioning calculation using the GPS time information and the orbit information included in the satellite signals, and acquire position information of the present location.

The portable device 300 functioning as the exercise support device can be configured by, for example, a smartphone or a tablet terminal device. The portable device 300 is connected to the wrist device 200 including a pulse wave sensor functioning as a biological sensor, which is a photoelectric sensor, by short range wireless communication, which can be illustrated by, for example, Bluetooth (registered trademark), wired communication, or the like (not shown in the figure).

Note that the wrist device 200 and the portable device 300 in this embodiment include a function of Bluetooth. The portable device 300 and the wrist device 200 are connected by Bluetooth communication. The Bluetooth communication can perform wireless communication between Bluetooth mounted devices in a range of a radius of approximately 10 to 100 m while performing a frequency hopping for dividing a 2.4 GHz band into a plurality of frequency channels and changing a frequency in use at random. Therefore, it is possible to suitably perform connection of the wrist device 200 and the portable device 300 such as pairing through the Bluetooth communication that has less directivity and is suitable for mobile communication as simple digital wireless communication.

Communication by Bluetooth Low Energy (also referred to as Bluetooth 4.0) is applied to the Bluetooth communication in this embodiment. The Bluetooth Low Energy (hereinafter referred to as BLE) is a standard of short range wireless communication in which radio in a 2.4 GHz band is used. Importance is placed on a power saving property. In the BLE, a host side and a device side perform communication with a profile called GATT (Generic ATTribute). By performing such communication applied with the BLE, it is possible to greatly save electric power compared with versions in the past. It is possible to increase a usable time of the wrist device.

The portable device 300 can be connected to the server 400 such as a PC (Personal Computer) or a server system via the network NE. As the network NE, various networks such as a WAN (Wide Area Network), a LAN (Local Area Network), and short range wireless communication can be used. In this case, the server 400 is realized as a processing storing section that receives pulse wave information and body motion information measured by the wrist device 200 from the portable device 300 via the network NE and stores the pulse wave information and the body motion information.

Note that the wrist device 200 only has to be capable of performing communication with the portable device 300 and does not need to be directly connected to the network NE. Therefore, it is possible to simplify the configuration of the wrist device 200. However, in the exercise support system 100, modified implementation is also possible in which the portable device 300 is omitted and the wrist device 200 and the server 400 are directly connected. In this case, the wrist device 200 includes a function of processing measurement information included in the portable device 300 and a function of transmitting measurement information to the server 400 and receiving information from the server 400.

The exercise support system 100 is not limited to the exercise support system 100 realized by the server 400. For example, the exercise support system 100 may be realized by the portable device 300. The portable device 300 such as a smartphone is often limited in processing performance, a storage region, and a battery capacity compared with a server system. However, it is also conceivable that sufficient processing performance and the like can be secured if the performance improvement in recent years is taken into account. Therefore, if the requirement of processing performance and the like is satisfied, the portable device 300 can be used as the exercise support system 100 according to this embodiment.

The exercise support system 100 according to this embodiment is not limited to the exercise support system 100 realized by one device. For example, the exercise support system 100 may include two or more devices among the wrist device 200, the portable device 300, and the server 400. In this case, processing executed by the exercise support system 100 may be executed in any one of the devices or may be distributedly performed by a plurality of devices. The exercise support system 100 according to this embodiment is not prevented from including devices different from the wrist device 200, the portable device 300, and the server 400.

Further, when improvement of terminal performance, a use form, or the like is taken into account, it is possible to adopt an embodiment in which the exercise support system 100 according to this embodiment is realized by the wrist device 200.

Processing of sections of the exercise support system 100 according to this embodiment can be realized by a computer program. That is, a method in this embodiment can be applied to a computer program for causing a computer to execute processing in which, at time when the user sets in advance that the wrist device 200 is not used, the wrist device 200 and the portable device 300 perform communication connection between the wrist device 200 and the portable device 300, after the communication connection is performed, the wrist device 200 transmits measurement information measured by the wrist device 200 to the portable device 300, the portable device 300 transmits the measurement information received from the wrist device 200 to the server 400 on the network NE, and the server 400 saves the measurement information received from the portable device 300.

The method in this embodiment can be applied to a computer program for causing the computer to execute processing in which the wrist device 200 recognizes that the wrist device 200 is at a standstill, the portable device 300 recognizes that the portable device 300 is at a standstill, the wrist device 200 and the portable device 300 transmit radio waves to each other on the basis of the recognitions and perform communication connection between the wrist device 200 and the portable device 300 on the basis of the radio waves transmitted to each other and, after the communication connection is established, the wrist device 200 transmits measurement information measured by the wrist device 200 to the portable device 300, the portable device 300 transmits the measurement information received from the wrist device 200 to the server 400 on the network NE, and the server 400 saves the measurement information received from the portable device 300.

Note that a state in which “the wrist device 200 and the portable device 300 are at a standstill” indicates a state in which there is no movement (motion) of the wrist device 200 and the portable device 300, in other words, a state in which the wrist device 200 and the portable device 300 are placed on a desk or the like away from the hand or the body of the user and are at a standstill (remain stationary) without moving.

The exercise support system 100 in this embodiment includes a memory that stores information (e.g., computer programs and various data) and a processor that operates on the basis of the information stored in the memory. For example, the processor may be realized by hardware, functions of which sections are separate or hardware, functions of which sections are integral. The processor may be, for example, a CPU (Central Processing Unit). However, the processor is not limited to the CPU. Various processors such as a GPU (Graphics Processing Unit) or a DSP (Digital Signal Processor) can be used. The processor may be a hardware circuit by an ASIC. The memory may be a semiconductor memory such as an SRAM (Static Random Access Memory) or a DRAM (Dynamic Random Access Memory), may be a register, may be a magnetic storage device such as a hard disk device, or may be an optical storage device such as an optical disk device. For example, the memory has stored therein commands readable by a computer. The commands are executed by the processor, whereby functions of the sections of the exercise support system 100 are realized. The commands may be commands configuring a computer program or may be commands for instructing the hardware circuit of the processor to operate.

### 2.1. Wrist Device

As shown in FIG. 3, the wrist device 200 is mounted on a given part (e.g., a measurement target part such as a wrist) of the user and detects pulse wave information, position information, and the like. The wrist device 200 includes, as shown in FIG. 2, a device main body 18 including a case section 30 and closely attached to the user to detect pulse wave information and the like and a pair of band sections 10 attached to the device main body 18 to mount the device main body 18 on the user. A display section 50 and an optical sensor section 40 are provided in the device main body 18 including the case section 30. Fitting holes 12 and a buckle 14 are provided in the band sections 10. The buckle 14 is configured from a buckle frame 15 and a locking section (a protrusion bar) 16.

Note that, in the following explanation of the wrist device 200, when the device main body 18 is mounted on the user, a side located on a target object (subject) side, which is a target part of measurement, is referred to as “rear side or rear surface side” and a display surface side of the device main body 18 on the opposite side of the side is referred to as “front side or a front surface side”. A “target object (target part) ” to be measured is sometimes referred to as “subject”. A coordinate system is set on the basis of the case section 30 of the wrist device 200. A direction crossing a display surface of the display section 50, that is, a direction from the rear surface toward the front surface when the display surface side of the display section 50 is defined as the front surface is set as a Z-axis positive direction. Alternatively, a direction from the optical sensor section 40 toward the display section 50 or a direction away from the case section 30 in the normal direction on the display surface of the display section 50 may be defined as the Z-axis positive direction. In a state in which the wrist device 200 is mounted on the subject, the Z-axis positive direction is equivalent to a direction from the subject toward the case section 30. Two axes orthogonal to the Z axis are set as X and Y axes. In particular, a direction in which the band sections 10 are attached to the case section 30 is set as the Y axis.

FIG. 2 is a perspective view of the wrist device 200 viewed from a −Z-axis direction, which is a direction on the band sections 10 side (a surface side on the subject side in a mounted state among surfaces of the case section 30), in a state in which the band sections 10 are fixed using the fitting holes 12 and the locking section 16. In the wrist device 200, a plurality of fitting holes 12 are provided in the band section 10. The locking section 16 of the buckle 14 is inserted into any one of the plurality of fitting holes 12 to mount the wrist device 200 on the user. The plurality of fitting holes 12 are provided along the longitudinal direction of the band section 10.

The device main body 18 includes, as shown in FIG. 4, the case section 30 including a top case 21 and a bottom case 22. The bottom case 22 is disposed on the side of the measurement target object, when the device main body 18 is attached to the user. The top case 21 is disposed on the opposite side of a measurement target object side (on the front side) with respect to the bottom case 22. A detection window 221 is provided on the rear surface of the bottom case 22. The optical sensor section 40 is provided in a position corresponding to the detection window 221.

In FIG. 2, a biological sensor (a photoelectric sensor 401 (see FIG. 4) functioning as a pulse wave sensor that acquires pulse wave information) is assumed. An example is shown in which the optical sensor section 40 is provided, in the case section 30, on a surface present on the subject side when the wrist device 200 is mounted. However, a position where the biological sensor is provided is not limited to the illustration in FIG. 2. For example, the biological sensor may be provided on the inside of the case section 30.

FIG. 3 is a diagram of the wrist device 200 viewed from a side on which the display section 50 is provided (a Z-axis direction) in a state in which the user wears the wrist device 200. As shown in FIG. 3, the wrist device 200 according to this embodiment includes the display section 50 in a position equivalent to a dial of a normal wristwatch or a position where the user can visually recognize numbers and icons. In the mounted state of the wrist device 200, the bottom case 22 (see FIG. 4) side of the case section 30 is closely attached to the subject and the display section 50 is in a position where the user can easily visually recognize the display section 50.

The configuration of the device main body 18 of the wrist device 200 is explained with reference to a sectional structure example shown in FIG. 4 and a functional block example shown in FIG. 5. As shown in FIG. 4, the device main body 18 includes, in addition to the top case 21 and the bottom case 22, a module board 35, an optical sensor section 40 connected to the module board 35, a circuit board 41, a panel frame 42, a circuit case 44, an LCD 501 configuring the display section 50, an acceleration sensor 55, which is an example of a body motion sensor, a secondary battery 60, a GPS antenna 65, and a CPU 90. However, the configuration of the wrist device 200 is not limited to the configuration shown in FIG. 4. It is possible to add other components and omit a part of the components.

The top case 21 may include a body section 211 and a glass plate 212. In this case, the body section 211 and the glass plate 212 are used as an outer wall that protects an internal structure and may be configured such that the user is capable of visually recognizing, via the glass plate 212, display on the display section 50 such as a liquid crystal display (hereinafter, LCD 501) provided right under the glass plate 212. That is, in this embodiment, various kinds of information such as detected biological information, information representing an exercise state, and time information may be displayed using the LCD 501. The display may be presented to the user from the top case 21 side. Note that, in the example explained above, a top plate portion of the device main body 18 is realized by the glass plate 212. However, the top plate portion can be configured by a material other than glass such as transparent plastic as long as the top plate portion is a transparent member through which the LCD 501 can be visually recognized and that has intensity enough for protecting components included in the inside of the case section 30 such as the LCD 501.

A detection window 221 and a light blocking section 222 are provided in the bottom case 22. The optical sensor section 40 is provided in a position corresponding to the detection window 221. The detection window 221 is configured to transmit light. Light emitted from a light emitting section 150 (see FIG. 5) included in the optical sensor section 40 is transmitted through the detection window 221 and irradiated on the subject (the measurement target object). Reflected light reflected on the subject is also transmitted through the detection window 221 and received in a light receiving section 140 (see FIG. 5) of the optical sensor section 40. That is, by providing the detection window 221, it is possible to perform detection of biological information using the photoelectric sensor 401. The optical sensor section 40 is connected to the module board 35. Note that the module board 35 is electrically connected to the circuit board 41 using a flexible board 47 or the like.

The panel frame 42 that guides a display panel such as the LCD 501 is disposed on one surface of the circuit board 41. The circuit case 44 that guides the secondary battery 60 and the like is disposed on the other surface of the circuit board 41. The CPU 90 functioning as a control circuit that controls a circuit that controls a GPS 160 (see FIG. 5) including the GPS antenna 65, a circuit that drives the optical sensor section 40 and measures a pulse wave (a pulse), and a circuit that drives the LCD 501 is mounted on the circuit board 41. The circuit board 41 is conducted to an electrode of the LCD 501 via a not-shown connector. Pulse measurement data such as a pulse rate, time information such as present time, and the like are displayed on the LCD 501 according to modes.

The rechargeable secondary battery 60 (lithium secondary battery) is guided to the circuit case 44. Terminals of both poles of the secondary battery 60 are connected to the circuit board 41 by a connection board 48 or the like. The secondary battery 60 supplies electric power to a circuit that controls electric power. The electric power is, for example, converted into a predetermined voltage by the circuit and supplied to the circuits. The electric power operates the circuit that drives the optical sensor section 40 and detects a pulse, the circuit that drives the LCD 501, the control circuit (the CPU 90) that controls the circuits, and the like. Charging of the secondary battery 60 is performed via a pair of charging terminals conducted to the circuit board 41 by a conduction member (not shown in the figure) such as a coil spring. Note that, in the example explained above, the secondary battery 60 is used as a battery. However, a primary battery, for which charging is unnecessary, maybe used as the battery.

As shown in FIG. 4, the detection window 221 may be formed to be extended to a sealing section 51 provided in a connecting section of the top case 21 and the bottom case 22. In the sealing section 51, a gasket 52 that seals the inside of the case section 30 from the outside may be provided. The gasket 52 is provided in the connecting section of the top case 21 and the bottom case 22 and seals the inside of the case section 30 from the outside.

The wrist device 200 includes, as functional components thereof, as shown in FIG. 5, the optical sensor section 40, the display section 50, a communication connection section 70, a communication section 80, the CPU 90, the GPS 160, a body-motion sensor section 170, and a storing section 180.

The optical sensor section 40 detects a pulse wave and the like. The optical sensor section 40 includes the light receiving section 140 and the light emitting section 150. As explained above, light emitted from the light emitting section 150 is irradiated on the subject (the measurement target object) and reflected light of the light is received by the light receiving section 140, whereby the optical sensor section 40 can detect pulse wave information. The optical sensor section 40 outputs, as a pulse wave detection signal, a signal detected by the pulse wave sensor. For example, a photoelectric sensor is used as the optical sensor section 40. In this case, it is conceivable to adopt, for example, a method of detecting, with the light receiving section 140, reflected light or transmitted light of light irradiated on a living organism (a wrist of the user) from the light emitting section 150. In such a method, since an absorption amount and a reflection amount of the irradiated light in the living organism are different depending on a blood flow rate in a blood vessel, sensor information detected by the photoelectric sensor changes to a signal corresponding to the blood flow rate and the like. It is possible to acquire information concerning pulsation by analyzing the signal. However, the pulse wave sensor is not limited to the photoelectric sensor. Other sensors such as an electrocardiograph and an ultrasonic sensor may be used.

The communication connection section 70 includes a radio-wave transmitting section 75. The communication connection section 70 can transmit a radio wave according to an instruction of the CPU 90 and perform communication connection between a host side (e.g., the wrist device 200) and a device side (e.g., the portable device 300).

The CPU 90 configures a control circuit for the circuit that drives the optical sensor section 40 and measures a pulse wave, the circuit that drives the display section 50 (the LCD 501), a control circuit for the communication connection section 70, a circuit that drives the body-motion sensor section 170 and detects body motion information, a circuit that controls the GPS 160, and the like. The CPU 90 transmits pulse wave information and body motion information detected in respective parts, position information of the user, or the like to the communication section 80. The communication section 80 transmits, to the portable device 300, the pulse wave information and the body motion information or the position information of the user transmitted from the CPU 90.

The GPS 160 includes the GPS antenna 65 and a signal processing section 66. The signal processing section 66 can perform positioning calculation on the basis of a plurality of satellite signals received by the GPS antenna 65 and acquire the satellite signals as position information of the user.

The body-motion sensor section 170 includes the acceleration sensor 55 and an azimuth sensor (a terrestrial magnetism sensor) 56. The body-motion sensor section 170 can detect information related to a motion of the body of the user, that is, body motion information. The body-motion sensor section 170 outputs a body motion detection signal, which is a signal that changes according to a body motion of the user.

The storing section 180 stores, according to the control by the CPU 90, biological information such as a pulse wave detected by the optical sensor section 40, position information detected by the GPS 160, body motion information detected by the body-motion sensor section 170.

### 2.2. Portable Device

The portable device 300 includes, as shown in FIG. 5, an information receiving section 280 that receives measurement information from the wrist device 200, a measurement-information processing section 210 that processes the measurement information received by the information receiving section 280, a communication connection section 220 that performs processing of communication connection with the wrist device 200, a control section (a CPU) 230 that performs processing for acquiring measurement information and position information and causing a storing section 240 or a notifying section 290 to store or notify the measurement information and the position information, the storing section 240 that stores acquired pulse wave information and body motion information of the user, position information, or the like, the notifying section 290 that notifies information processed by the control section (the CPU) 230, and a communication processing section 295 that performs communication processing with the outside.

However, the portable device 300 is not limited to the configuration shown in FIG. 5. Various modified implementations are possible in which, for example, a part of the components is omitted and other components are added. For example, the portable device 300 may include the optical sensor section 40 and the body-motion sensor section 170 included in the wrist device 200 or the GPS 160.

The information receiving section 280 receives measurement information detected and measured by the wrist device 200 and transmitted from the communication section 80.

The measurement-information processing section 210 acquires pulse wave information and body motion information of the user detected by the optical sensor section 40 and the body-motion sensor section 170 included in the wrist device 200. The measurement-information processing section 210 includes a signal processing section 215 that processes a signal (pulse wave information) detected by the optical sensor section 40 and a signal (body motion information) detected by the body-motion sensor section 170.

The signal processing section 215 performs various kinds of signal processing (filter processing, etc.). The optical sensor section 40 performs signal processing on, for example, a pulse wave detection signal transmitted from the optical sensor section 40 and a body motion detection signal transmitted from the body-motion sensor section 170. The signal processing section 215 includes, for example, a body-motion-noise reducing section 216. The body-motion-noise reducing section 216 performs, on the basis of the body motion detection signal transmitted from the body motion sensor section 170, processing for reducing (removing) body motion noise, which is noise due to a body motion, from the pulse wave detection signal. Specifically, the body-motion-noise reducing section 216 performs noise reduction processing using, for example, an adaptive filter.

The communication connection section 220 includes a radio-wave transmitting section 225. The communication connection section 220 can transmit a radio wave according to an instruction of the control section (the CPU) 230 and perform communication connection between a host side (e.g., the wrist device 200) and a device side (e.g., the portable device 300).

The control section (the CPU) 230 performs various kinds of signal processing and control processing, for example, using the storing section 240 as a work region. The control section 230 can be realized by a processor such as a CPU or a logical circuit such as an ASIC. The control section (the CPU) 230 includes a position-information acquiring section 232, a measurement-information acquiring section 234, and a notification control section 236. Note that the control section (the CPU) 230 recognizes time when the user sets in advance that the wrist device 200 is not used or a state in which the wrist device 200 and the portable device 300 are at a standstill and instructs the server 400 to store measurement information.

The position-information acquiring section 232 generates present position information and movement information of the user on the basis of position information and time information measured and calculated by the GPS 160 included in the wrist device 200 or azimuth information acquired by the azimuth sensor 56 included in the wrist device 200. Note that the position-information acquiring section 232 can save the generated present position information and the generated movement information in the storing section 240 or change the generated present position information and the generated movement information to notification data with the notification control section 236.

The measurement-information acquiring section 234 generates activity information of the user on the basis of pulse wave information and body motion information of the user detected by the optical sensor section 40 and the body motion sensor section 170 included in the wrist device 200. Note that the measurement-information acquiring section 234 can save the generated pulse wave information and body motion information in the storing section 240 or change the generated pulse wave information and body motion information to notification data with the notification control section 236.

The notification control section 236 performs, on the basis of the present position information and the movement information of the user generated by the position-information acquiring section 232 or the activity information of the user generated by the measurement-information acquiring section 234, control processing such as generation of notification data for notifying the present position information and the movement information or the activity information and a notification instruction to the notifying section 290. The notification control section 236 transmits a notification signal subjected to the control processing to the notifying section 290 or transmits, via the communication processing section 295, the notification signal to a notifying section (not shown in the figure) provided in a device on the network NE.

The storing section 240 stores the present position information and the movement information of the user generated by the position-information acquiring section 232 or the activity information of the user generated by the measurement-information acquiring section 234. The storing section 240 stores a computer program for causing a computer to execute a series of processing of the exercise support system 100 according to this embodiment. The memory can be configured by a semiconductor memory such as an SRAM (Static Random Access Memory) or a DRAM (Dynamic Random Access Memory), a magnetic storage device such as a hard disk device, or an optical storage device such as an optical disk device.

The notifying section 290 notifies various kinds of information to the user according to the control by the notification control section 236. The notifying section 290 includes a display section 291 formed by, for example, a liquid crystal display that performs image display. The notifying section 290 displays, as an image, the present position information and the movement information or the activity information on the display section 291 on the basis of, for example, a data signal sent from the notification control section 236. Note that, as another notification method, the notifying section 290 can include a vibrating section 292 using a vibrating motor (a vibrator) or the like or a light emitting body (not shown in the figure) for notification using an LED or the like. The vibrating section 292 notifies various kinds of information to the user with intensity, length, or the like of vibration of the vibrating motor (the vibrator). The light emitting body for notification notifies the various kinds of information to the user with lighting, flashing, or the like of the light emitting body. Note that these kinds of information may be only displayed as an image or may be notified by combining the image display with at least one of the vibration and the light emission for notification.

The communication processing section 295 performs communication processing for transmitting the notification signal subjected to the control processing by the notification control section 236 to a notification function section provided in another terminal device or the like. In this case, the communication processing section 295 can perform processing of wireless communication according to a standard such as Bluetooth without using the network NE. The notification signal transmitted by the communication processing section 295 can be an image signal, a vibration signal, a light emission signal, or the like. The communication processing section 295 is connected to the server 400 such as a PC or a server system via the network NE.

### 3. Exercise Support Method

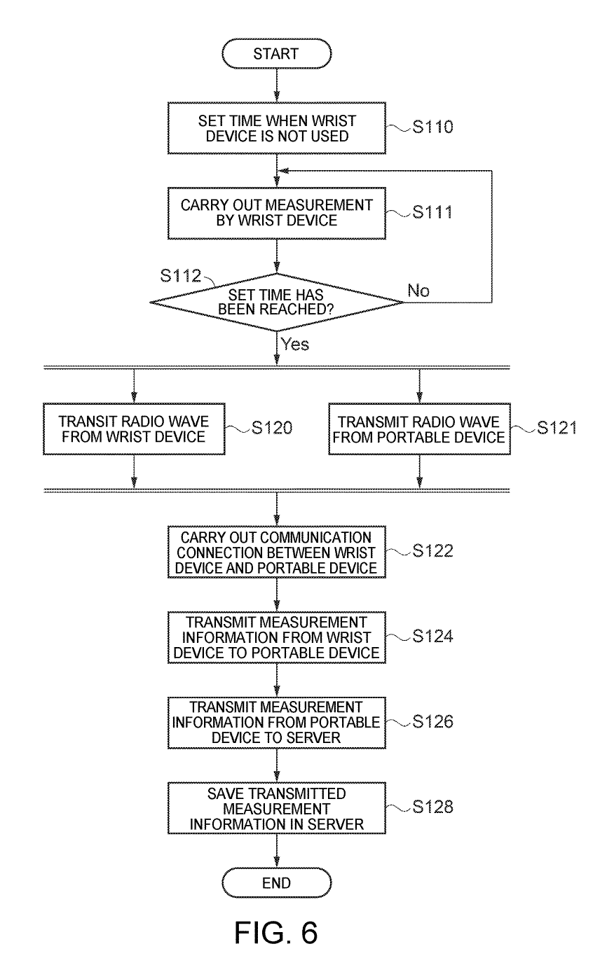

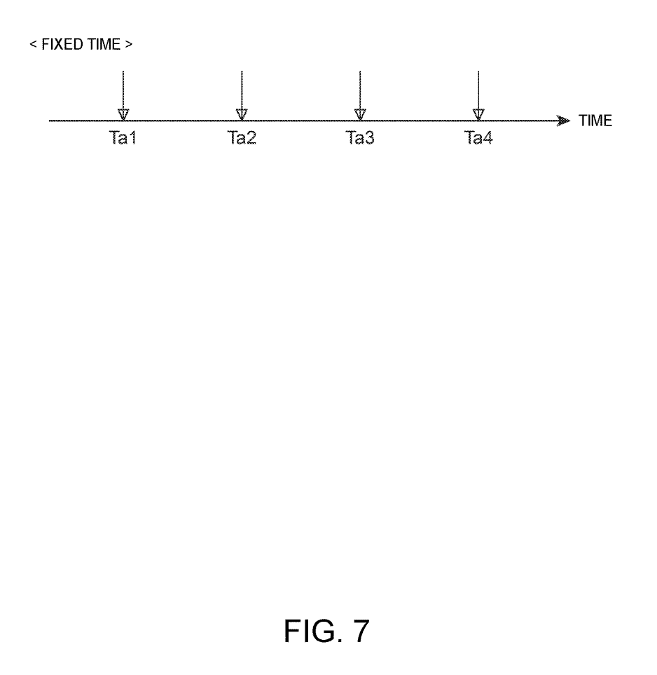

An example 1 of an operation procedure of the exercise support system is explained with reference to FIGS. 6 and 7. FIG. 6 is a flowchart for explaining the example 1 of the operation procedure of the exercise support system. FIG. 7 is a diagram for explaining timing of communication connection in the example 1.

### 3.1. Operation Procedure of the Exercise Support System According to the Example 1

The example 1 of the operation procedure of the exercise support system 100 includes, as shown in FIG. 6, step 5110 for setting time when the wrist device 200 is not used, step S111 for performing measurement with the wrist device 200, step S112 for determining whether the set time has been reached, step S120 for transmitting a radio wave from the wrist device 200 and step S121 for transmitting a radio wave from the portable device 300, step S122 for performing communication connection between the wrist device 200 and the portable device 300, step S124 for transmitting measurement information from the wrist device 200 to the portable device 300, step S126 for transmitting the measurement information from the portable device 300 to the server 400, and step S128 for saving the transmitted measurement information in the server 400.

Procedures are explained for each of the steps according to the flowchart of FIG. 6. Note that, in the following explanation of the procedures, the same reference numerals and signs as the reference numerals and signs used for the explanation of the configuration of the exercise support system 100 are used. The wrist device 200 and the portable device 300 configuring the exercise support system 100 carryout so-called pairing for selecting devices connected to each other through Bluetooth communication (BLE) and authenticating the devices using the same code number (registration key) each other.

First, the user sets time when the wrist device 200 is not used (step S110). The setting of the time can be performed in the wrist device 200 or the portable device 300. As a method of setting the time when the wrist device 200 is not used, a method of setting time at every predetermined interval, for example, as indicated by arrows Ta1 to Ta4 shown in FIG. 7 or a method of setting any time can be used. Note that the time can be reworded as time for transmitting various kinds of measurement information stored in the storing section 240 to the server 400 on the network NE and causing the server 400 to save the measurement information.

Subsequently, the user wearing the wrist device 200 measures pulse wave information, position information, and body motion information with the respective sensors included in the wrist device 200, the GPS 160, and the like (step S111). Note that the measured pulse wave information, position information, body motion information, and the like are stored in the storing section 180.

Subsequently, the control section (the CPU) 230 determines whether the time when the wrist device 200 is not used is set in advance by the user has been reached (step S112). If the time when the user sets in advance that the wrist device 200 is not used has been reached (Yes in step S112), the control section (the CPU) 230 causes the radio-wave transmitting section 75 included in the wrist device 200 to transmit a radio wave (step S120), causes the radio-wave transmitting section 225 included in the portable device 300 to transmit a radio wave (step S121), and performs communication connection between the wrist device 200 and the portable device 300 (step S122). Note that, if the time when the user sets in advance that the wrist device 200 is not used has not been reached (No in step S112), the control section (the CPU) 230 continues the measurement of pulse wave information, position information, and body motion information by the wrist device 200.

After the communication connection between the wrist device 200 and the portable device 300 is performed, the control section (the CPU) 230 transmits measurement information such as the pulse wave information, the position information, and the body motion information from the wrist device 200 to the portable device 300 (step S124). The CPU 90 included in the wrist device 200 reads out, on the basis of an instruction of the control section (the CPU) 230 included in the portable device 300, the measurement information such as the pulse wave information, the position information, and the body motion information stored in the storing section 180 and transmits the measurement information to the information receiving section 280 included in the portable device 300 via the communication section 80.

Subsequently, the control section (the CPU) 230 transmits the measurement information such as the pulse wave information, the position information, and the body motion information transmitted from the wrist device 200 and the measurement information stored in the storing section 240 included in the portable device 300 to the server 400 on the network NE via the communication processing section 295 (step S126).

Subsequently, the control section (the CPU) 230 saves, in the server 400, the measurement information such as the pulse wave information, the position information, and the body motion information transmitted to the server 400 (step S128). The series of procedures are ended by step S128.

With the exercise support system 100 in the operation procedure according to the example 1 explained above, the communication connection between the wrist device 200 and the portable device 300 is performed at the time when the user sets in advance that the wrist device 200 is not used. While the wrist device 200 is not used after the communication connection is performed, that is, while functions such as measurement do not work, the measurement information can be transmitted from the wrist device 200 to the server 400 on the network NE via the portable device 300 and saved in the server 400. Therefore, it is possible to eliminate a trouble that the user cannot use the wrist device 200 during the transmission of the measurement information.

### 3.2. Operation Procedure of the Exercise Support System According to an Example 2

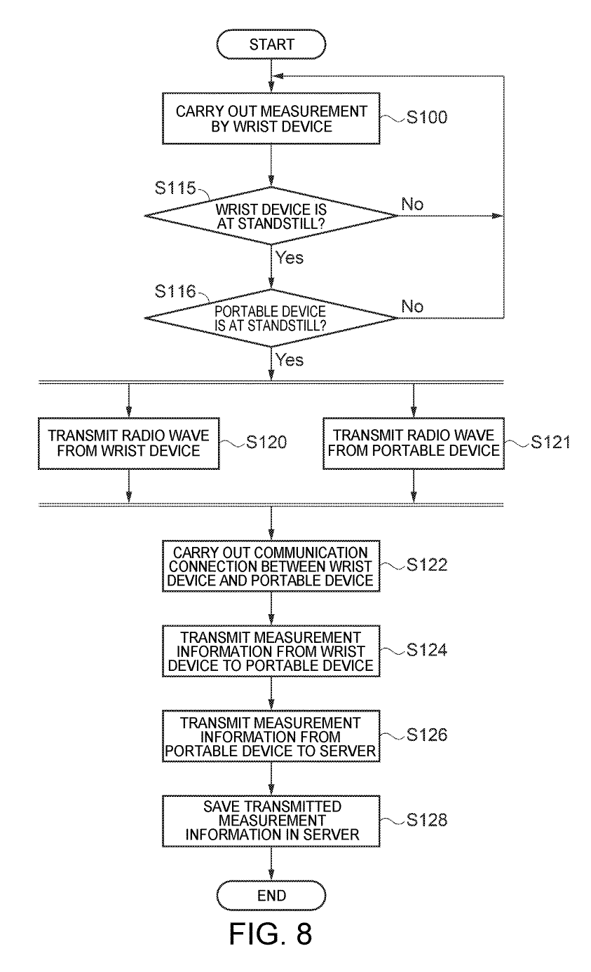

An example 2 of the operation procedure of the exercise support system is explained with reference to FIG. 8. FIG. 8 is a flowchart for explaining the example 2 of the operation procedure of the exercise support system. Note that, in the following explanation of procedures, the same reference numerals and signs as the reference numerals and signs used for the explanation of the configuration of the exercise support system 100 are used. The wrist device 200 and the portable device 300 configuring the exercise support system 100 carryout so-called pairing for selecting devices connected to each other through Bluetooth communication (BLE) and authenticating the devices using the same code number (registration key) each other.

The example 2 of the operation procedure of the exercise support system 100 shown in FIG. 8 is different from the example 1 of the operation procedure in procedure in step S120 for transmitting a radio wave from the wrist device 200 to perform communication connection between the wrist device 200 and the portable device 300 (step S122) and step S121 for transmitting a radio wave from the portable device 300. Therefore, in the following explanation, the different procedures are explained. Explanation of the same procedures is omitted.

The example 2 of the operation procedure of the exercise support system 100 includes, as shown in FIG. 8, before step S120 for transmitting a radio wave from the wrist device 200 performed for the communication connection between the wrist device 200 and the portable device 300 in step S122 and step S121 for transmitting a radio wave from the portable device 300, a step (step S115) for determining whether the wrist device 200 is at a standstill and a step (step S116) for determining whether the portable device 300 is at a standstill.

The user measures pulse wave information, position information, and body motion information with the respective sensors included in the wrist device 200 mounted on the wrist or the like of the user, the GPS 160, and the like (step S100). Note that the measured pulse wave information, position information, body motion information, and the like are stored in the storing section 180 included in the wrist device 200.

Subsequently, the control section (the CPU) 230 determines whether the wrist device 200 is at a standstill (step S115). When determining in step S115 that the wrist device 200 is at a standstill (Yes in step S115), the control section (the CPU) 230 shifts to the next step S116 for determining whether the portable device 300 is at a standstill. When determining in step S116 that the portable device 300 is at a standstill (Yes at step S116), the control section (the CPU) 230 shifts to the next step, causes the radio-wave transmitting section 75 included in the wrist device 200 to transmit a radio wave (step S120), causes the radio-wave transmitting section 225 included in the portable device 300 to transmit a radio wave (step S121), and performs communication connection between the wrist device 200 and the portable device 300 with the respective radio waves (step S122).

Note that, when determining in step S115 that the wrist device 200 is not at a standstill (No in step S115) and when determining in step S116 that the portable device 300 is not at a standstill (No at step S116), the control section (the CPU) 230 returns to step S100 and continues the measurement of pulse wave information, position information, and body motion information by the wrist device 200.

A state in which “the wrist device 200 and the portable device 300 are at a standstill” indicates a state in which there is no movement (motion) of the wrist device 200 and the portable device 300, in other words, a state in which the wrist device 200 and the portable device 300 are placed on a desk or the like away from the hand or the body of the user and are at a standstill (remain stationary) without moving. Such a state can be determined according to an output of the acceleration sensor 55 included in the wrist device 200. In the portable device 300, it is also possible to determine the state by including an acceleration sensor (not shown in the figure) in the portable device 300.

Stpe S122 for performing communication connection between the wrist device 200 and the portable device 300 and the following steps S124, S126, and S128 are the same as the steps in the example 1 of the operation procedure. Therefore, explanation of the steps is omitted.

With the exercise support system 100 in the operation procedure according to the example 2, each of the wrist device 200 and the portable device 300 recognizes that the wrist device 200 and the portable device 300 are at a standstill, transmits a radio wave, and performs the communication connection. After the communication connection is established, while the wrist device 200 and the portable device 300 are at a standstill, that is, the wrist device 200 and the portable device 300 are not used, measurement information can be transmitted from the wrist device 200 to the server 400 on the network NE via the portable device 300 and saved in the server 400. Therefore, it is possible to eliminate a trouble that the user cannot use the wrist device 200 during the transmission of the measurement information.

With the exercise support system 100 explained above, the communication connection between the wrist device 200 and the portable device 300 is performed at the time when the wrist device 200 is not used. Alternatively, each of the wrist device 200 and the portable device 300 recognizes that the wrist device 200 and the portable device 300 are at a standstill, transmits a radio wave, and performs the communication connection. After the communication connection is established, that is, while the wrist device 200 and the portable device 300 are not used, measurement information can be transmitted from the wrist device 200 to the server 400 on the network NE via the portable device 300 and saved in the server 400. Therefore, it is possible to eliminate a trouble that the user cannot use the wrist device 200 during the transmission of the measurement information.

### 3.3. Other Operation Procedures of the Exercise Support System

In the exercise support system 100, an assist-type GPS (A-GPS) can be applied in positioning calculation of the GPS. A transmission procedure of assist data of the GPS in the case in which the assist-type GPS (A-GPS) is applied in the exercise support system 100 is explained.

The assist-type GPS (A-GPS) is explained. The assist-type GPS (A-GPS) is a system that, in order to complement a GPS that acquires position information using radio waves from GPS satellites, performs positioning secondarily using assist data of the GPS received by secondarily using data communication of a portable device (e.g., a cellular phone). However, as the assist data of the GPS, it is necessary to receive new assist data of the GPS periodically, for example, in every two hours.

In positioning of a general GPS, the GPS repeatedly searches for satellites first, grasps the positions of all the satellites, searches for other satellites. Therefore, a build-up time in an initial state is necessary in units of minute. On the other hand, the assist-type GPS (A-GPS) acquires assist data (satellite orbit data) of the GPS through the data communication of the portable device and obtains orbit data from a server to thereby perform positioning. Therefore, it is possible to reduce the build-up time in the initial state. Specifically, the portable device (the cellular phone) originally always communicates with a base station to perform a call. It is always known that the portable device (the cellular phone) is generally present in a range of approximately several kilometers and in a maximum range of approximately several ten kilometers. Therefore, when a request for positioning is transmitted from the portable device, it is possible to select and transmit orbit data and the like of satellites that can be measured in approximate positions. It is possible to position a present position at an extremely short time. By applying the assist-type GPS (A-GPS), it is easy to perform positioning when the user is present in a shield, for example, in a building or the user is surrounded by walls of the building.

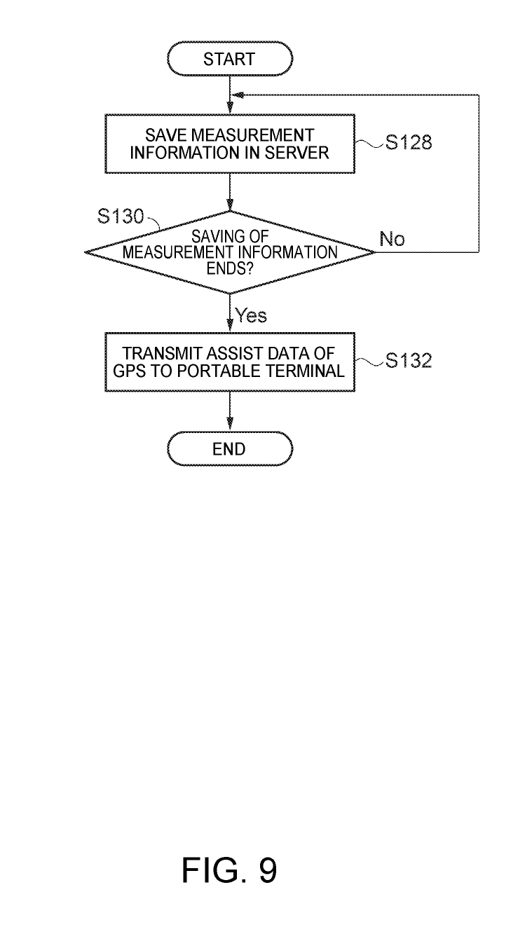

First, an illustration 1 of a transmission procedure of assist data of the GPS related to the A-GPS is explained with reference to FIG. 9. FIG. 9 is a flowchart for explaining the illustration 1 of the transmission procedure of the assist data of the GPS related to the A-GPS.

As the transmission procedure of the assist data of the GPS according to the illustration 1, as shown in FIG. 9, the control section (the CPU) 230 saves, in the server 400, measurement information such as pulse wave information, position information, and body motion information transmitted to the server 400 (step S128). The control section (the CPU) 230 determines whether the saving of the measurement information in the server 400 is completed in step S128 (step S130). When saving of the measurement information by the server 400 is completed in step S130 (Yes in step S130), the server 400 transmits the assist data of the GPS to the wrist device 200 (step S132). Note that, when the saving of the measurement information in the server 400 is not completed in step S130 (No in step S130), the server 400 continues the saving of the measurement information.

According to the transmission procedure of the assist data of the GPS according to the illustration 1, in a state in which the saving of the measurement information is completed and a load on the wrist device 200 is reduced, the assist data of the GPS is transmitted to the wrist device 200. Therefore, the wrist device 200 can surely and easily obtain the assist data of the GPS.

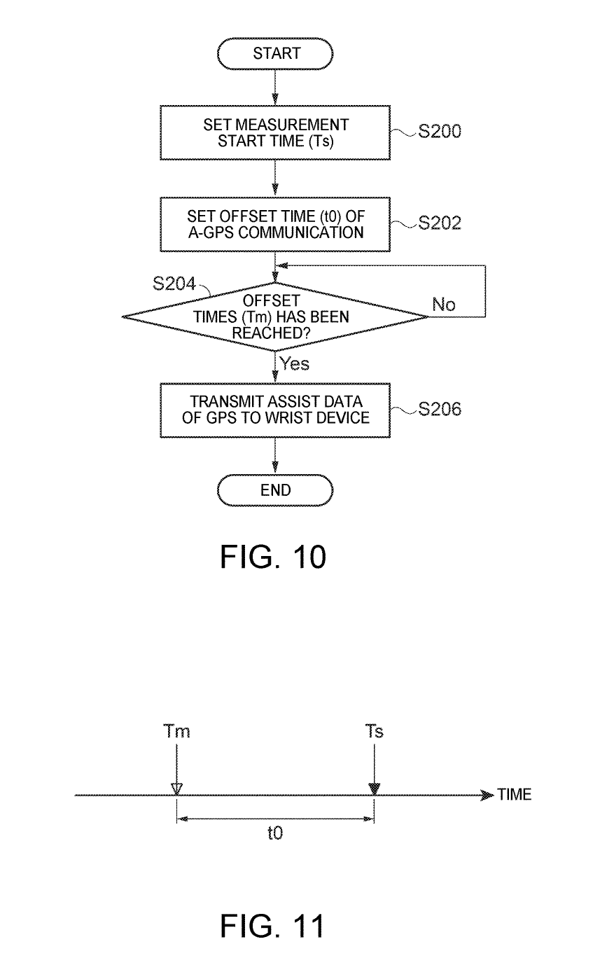

An illustration 2 of the transmission procedure of the assist data of the GPS related to the A-GPS is explained with reference to FIGS. 10 and 11. FIG. 10 is a flowchart for explaining the illustration 2 of the transmission procedure of the assist data of the GPS related to the A-GPS. FIG. 11 is a diagram for explaining transmission timing of the illustration 2.

In the transmission procedure of the assist data of the GPS according to the illustration 2, as shown in FIGS. 10 and 11, first, the user sets measurement start time Ts of measurement by the wrist device 200 (step S200). Subsequently, the user sets, on the basis of the set measurement start time, an offset time t0 retroactive from the measurement start time (step S202) and sets the offset time t0 as time Tm when communication of the A-GPS is started.

Subsequently, the server 400 determines whether the time Tm when the communication of the A-GPS is started has been reached (step S204). When the time Tm when the communication of the A-GPS is started has been reached (Yes in step S204), the server 400 transmits the assist data of the GPS to the wrist device 200 (step S206). Note that when the time Tm when the communication of the A-GPS is started has not been reached (No in step S204), the server 400 stays on standby until the time Tm when the communication of the A-GPS is started is reached.

With the transmission procedure of the assist data of the GPS according to the illustration 2, the assist data of the GPS is transmitted to the wrist device 200 according to the time Tm when the communication of the A-GPS is started set on the basis of the measurement start time Ts. Therefore, the wrist device 200 can surely obtain the assist data of the GPS.

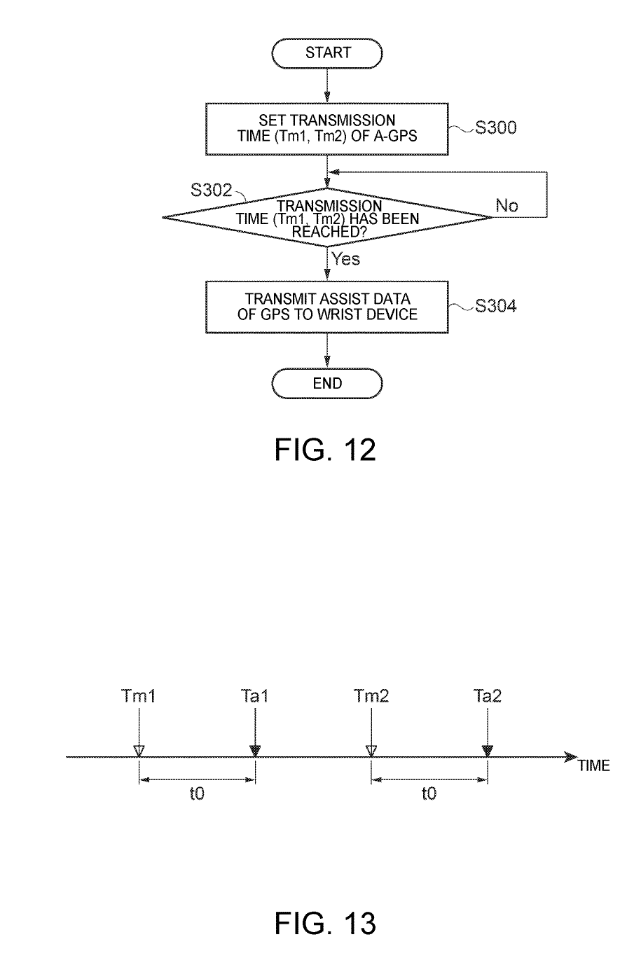

An illustration 3 of the transmission procedure of the assist data of the GPS related to the A-GPS is explained with reference to FIGS. 12 and 13. FIG. 12 is a flowchart for explaining the illustration 3 of the transmission procedure of the assist data of the GPS related to the A-GPS. FIG. 13 is a diagram for explaining transmission timing in the illustration 3.

In the transmission procedure of the assist data of the GPS according to the illustration 3, as shown in FIGS. 12 and 13, first, the user sets, from measurement start time Ta1 and Ta2 by the wrist device 200, with reference to the offset time to, transmission time Tm1 and Tm2 when the assist data of the GPS is transmitted to the wrist device 200 (step S300).

Subsequently, the server 400 determines whether the transmission time Tm1 or the transmission time Tm2 when communication of the A-GPS is started has been reached (step S302). When the transmission time Tm1 or the transmission time Tm2 when the communication of the A-GPS is started has been reached in step S302 (Yes in step S302), the server 400 transmits the assist data of the GPS to the wrist device 200 (step S304). Note that when the transmission time Tm1 or the transmission time Tm2 when the communication of the A-GPS is started has not been reached in step S302 (No in step S302), the server 400 stays on standby until the transmission time Tm1 or the transmission time Tm2 when the communication of the A-GPS is started is reached.

With the transmission procedure of the assist data of the GPS according to the illustration 2, the assist data of the GPS is transmitted to the wrist device 200 on the basis of the preset transmission time Tm1 or the transmission time Tm2 when transmission is started. Therefore, the wrist device 200 can surely obtain the assist data of the GPS.

### 3.4. Modification of the Wrist Device

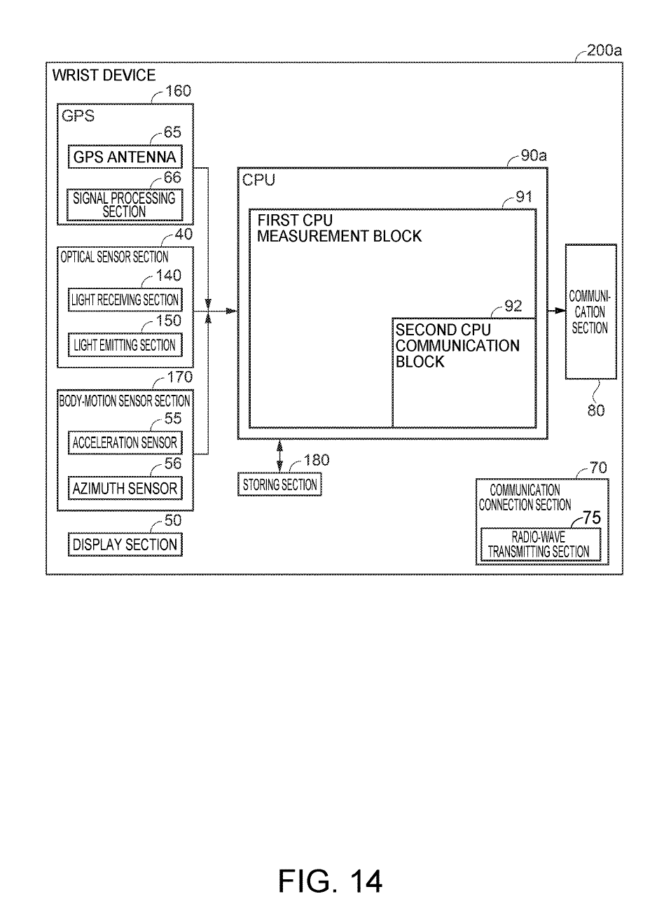

A modification related to the configuration of the wrist device included in the exercise support system 100 is explained with reference to FIG. 14. FIG. 14 is a block diagram showing the modification related to the configuration of the wrist device. Note that, in the following explanation, the same components as the components in the embodiment are denoted by the same reference numerals and signs and explanation of the components is omitted.

A wrist device 200a according to the modification includes, as functional components thereof, as shown in FIG. 14, the optical sensor section 40, the display section 50, the communication connection section 70, the communication section 80, a CPU 90a, the GPS 160, the body-motion sensor section 170, and the storing section 180. The wrist device 200a according to the modification is different from the embodiment in the configuration of the CPU 90a.

The CPU 90a includes a first CPU 91 that controls a measurement block and a second CPU 92 that controls a communication block. The first CPU 91 and the second CPU 92 can respectively perform separate operations. When the operation is unnecessary, the first CPU 91 and the second CPU 92 can stop functions thereof.

The first CPU 91 controls the operation of the measurement block including the GPS 160, the optical sensor section 40, and the body-motion sensor section 170 and performs control related to a clocking function and a display function (the display section 50) not shown in the figure. That is, when the user wears the wrist device and the respective sensors are operating, the control is performed by the first CPU 91.

The second CPU 92 controls the communication section 80 that performs communication processing with the portable device 300 (see FIG. 5) and the communication connection section 70. The second CPU 92 performs control of, for example, operation for transmitting measurement information to the portable device 300 and operation for performing communication connection to the portable device 300 in which a load related to processing during the operation is relatively large, in other words, consumption of battery energy is large. Note that, when the communication operation is unnecessary, the second CPU 92 stops the function thereof.

In this way, by dividing the CPU 90a into the first CPU 91 and the second CPU 92, only when functions related to the first CPU 91 and the second CPU 92 are operated, it is possible to separately operate the first CPU 91 and the second CPU 92. It is possible to operate the second CPU 92, which controls the operation in which a load related to processing during the operation is relatively large, in other words, consumption of battery energy (consumed power) is large, only when the function of the second CPU 92 is necessary and usually keep the second CPU 92 in a stopped state. Consequently, it is possible to reduce power consumption of the wrist device 200a. Therefore, it is possible to delay exhaustion of a battery (a primary battery or a secondary battery), that is, increase battery life.

Note that, in the embodiment explained above, the GPS including the GPS satellites 8 as the position information satellites included in the global navigation satellite system (GNSS) is illustrated. However, this is only an example. The global navigation satellite system only has to be a global navigation satellite system like other systems such as GALILEO (EU), GLONASS (Russia), and BeiDou (China) or a system including position information satellites that transmit satellite signals such as geostationary satellites such as SBAS or quasi-zenith satellites. That is, the wrist devices 200 and 200a may be configured to acquire any one of date information, time information, position information, and speed information grasped by processing radio waves (wireless signals) from position information satellites including satellites other than the GPS satellites 8. Note that the global navigation satellite system can be a regional navigation satellite system (RNSS).

The entire disclosure of Japanese Patent Application No. 2016-187876 filed Sep. 27, 2016 is expressly incorporated by reference herein.

What is claimed is:

1. A system that performs communication connection between a wrist device and a portable device at time when the user sets in advance that the wrist device is not used, wherein
after the communication connection is performed, the wrist device transmits measurement information measured by the wrist device to the portable device,
the portable device transmits the measurement information received from the wrist device to a server on a network, and
the server saves the measurement information received from the portable device.

2. The system according to claim 1, wherein the communication connection is performed by Bluetooth (registered trademark) communication.

3. The system according to claim 2, wherein the Bluetooth communication is communication by Bluetooth Low Energy.

4. The system according to claim 1, wherein the wrist device includes a global navigation satellite system.

5. The system according to claim 4, wherein
the global navigation satellite system is a GPS, and
the server transmits assist data of the GPS to the wrist device after the saving of the measurement information is completed.

6. The system according to claim 5, wherein the server transmits the assist data of the GPS to the wrist device on the basis of measurement start time set in advance by the user.

7. The system according to claim 5, wherein the server transmits the assist data of the GPS to the wrist device on the basis of transmission time set in advance by the user.

8. A system, wherein
a wrist device recognizes that the wrist device is at a standstill,
a portable device recognizes that the portable device is at a standstill,
the wrist device and the portable device transmit radio waves to each other on the basis of the recognitions and perform communication connection between the wrist device and the portable device on the basis of the radio waves transmitted to each other,
after the communication connection is performed, the wrist device transmits measurement information measured by the wrist device to the portable device,
the portable device transmits the measurement information received from the wrist device to a server on a network, and
the server saves the measurement information received from the portable device.

9. The system according to claim 8, wherein the communication connection is performed by Bluetooth (registered trademark) communication.

10. The system according to claim 9, wherein the Bluetooth communication is communication by Bluetooth Low Energy.

11. The system according to claim 8, wherein the wrist device includes a global navigation satellite system.

12. The system according to claim 11, wherein
the global navigation satellite system is a GPS, and
the server transmits assist data of the GPS to the wrist device after the saving of the measurement information is completed.

13. The system according to claim 12, wherein the server transmits the assist data of the GPS to the wrist device on the basis of measurement start time set in advance by the user.

14. The system according to claim 12, wherein the server transmits the assist data of the GPS to the wrist device on the basis of transmission time set in advance by the user.
